(19) United States
(12) Patent Application Publication
(10) Pub. No.: US 2005/0262149 A1
(43) Pub. Date: Nov. 24, 2005

(54) Method of and apparatus for reproducing downloaded data along with data recorded on storage medium

(75) Inventors: Kil-soo Jung, Hwaseong-si (KR); Sung-wook Park, Seoul (KR); Kwang-min Kim, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/129,304

(22) Filed: May 16, 2005

(30) Foreign Application Priority Data
May 17, 2004 (KR) 2004-34635

(51) Int. Cl. G06F 17/00

(52) U.S. Cl. 707/104.1

(57) ABSTRACT

A method of and apparatus for reproducing downloaded data along with data recorded on a storage medium. Data downloaded from an external database through a network are bound with data recorded on the storage medium. Accordingly, contents stored in a local storage after being downloaded from the external database can be smoothly reproduced along with data recorded on the storage medium. The bound data are stored in a virtual data structure corresponding to a data structure of the storage medium.

### CROSS-REFERENCE TO RELATED PATENT APPLICATIONS

This application claims the benefit of Korean Patent Application No. 2004-34635, filed on May 17, 2004, in the Korean Intellectual Property Office, the disclosure of which is incorporated herein by reference.

### BACKGROUND OF THE INVENTION

1. Field of the Invention

An aspect of the present invention relates to a method of and an apparatus for reproducing multimedia data recorded on a storage medium, and more particularly, to a method of and an apparatus for reproducing multimedia data recorded on a storage medium along with multimedia data downloaded through a network.

2. Description of the Related Art

Currently, moving picture data recorded on a storage medium such as a digital versatile disk (DVD) include compression-coded audio visual (AV) data and navigation data for controlling reproduction of the AV data.

More specifically, the AV data are formed with AV streams including encoded video, audio, and/or subtitle data complying with moving picture experts group (MPEG) standards. Additional information, such as encoding attributes of AV streams or entry points for random access and playlists generated according to a predetermined reproduction order of moving pictures, may be further included in the AV streams.

The navigation data are formed with navigation commands for controlling reproduction of the AV data, such as a command for reproducing a playlist or a command for accessing another playlist. Accordingly, by referring to the navigation data of a storage medium, the AV data may be reproduced and a user can watch moving pictures such as a movie with a high picture quality.

However, the moving picture data produced with the data structure described above has problems in that it is difficult to edit or modify the AV data after production of the storage medium is completed, and a data interactive function only allows a user to minimally modify the data. Accordingly, demands for an application having a programming function in addition to moving picture data functions are increasing.

In particular, there is a need for a function that allows new contents to be downloaded from an external database through a network, and to reproduce the downloaded data along with the data already recorded on the storage medium.

### SUMMARY OF THE INVENTION

An aspect of the present invention provides a method and an apparatus by which new contents downloaded from an external database through a network are reproducible along with moving picture data recorded on a storage medium.

According to an aspect of the present invention, there is provided a method of reproducing data from a storage medium on which moving picture data and application data providing an interactive function using the moving picture data are recorded, the method including: binding data downloaded from an external database through a network with the data recorded on the storage medium; and reproducing together the bound data.

In the binding of the data, by using meta information for connecting the downloaded data with the data recorded on the storage medium to reproduce the downloaded data along with the recorded data, a directory structure of a data file to be reproduced may be generated.

The meta information may include information on a data file which is recorded on the storage medium and connectable with the downloaded data. The meta information may further include version information of a downloaded file to avoid downloading of already downloaded data, information on a usage purpose of the downloaded data, and information on a download unit.

The meta information may be downloaded from the external database together with the downloaded data, may be stored in a separate area of a local storage in a reproducing apparatus, and may be stored as an attribute of a hidden file.

In the reproducing of the bound data, the data file to be reproduced may be reproduced based on the directory structure of the data file to be reproduced, wherein the directory structure is generated in the binding of the data.

In the binding of the data, in order to connect the downloaded data with the data recorded on the storage medium to reproduce the downloaded data along with the recorded data, a directory structure of a data file to be reproduced may be generated by using a predetermined file naming rule.

Where only one data file is downloaded to replace a predetermined file on the storage medium, the name of the data file to be downloaded may include the name of the file desired to be replaced and version information to avoid redundant downloading.

In relation to the name of the data file to be downloaded, in case of a plurality of data files to be provided additionally to the main video stream of the storage medium, the name of each of the plurality of data files may include an identical name to indicate that the plurality of data files are one download unit.

In case of a clip audio visual (AV) stream file, the name of the data file to be downloaded may further include information indicating the usage purpose of the stream, information on the identifier of the clip AV stream file, and version information of the clip AV stream file. In case of the clip AV stream file, the name of the data file to be downloaded may include the same name as the name of the clip AV stream file.

In case of a playlist file that is a reproduction unit of the clip, the name of the data file to be downloaded may further include information on a playlist that should be connected in the storage medium.

According to another aspect of the present invention, there is provided an apparatus for reproducing data from a storage medium on which moving picture data and application data providing an interactive function using the moving picture data are recorded, the apparatus including: a reading unit reading data recorded on the storage medium; a storage unit storing data downloaded from an external database through a network; and a reproducing unit reproducing data read from the storage medium along with the downloaded data stored in the storage unit, wherein the reproducing unit includes an application manager binding the downloaded data with the data recorded on the storage medium.

The application manager may generate a directory structure of a data file to be reproduced by using meta information for connecting the downloaded data with the data recorded on the storage medium to reproduce the downloaded data along with the recorded data.

In order to connect the downloaded data with the data recorded on the storage medium to reproduce the downloaded data along with the recorded data, the application manager may generate a directory structure of a data file to be reproduced by using a predetermined file naming rule.

The application data may be implemented by using a programming language. The programming language may be Java.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates types of data recorded on a storage medium according to an aspect of the present invention;

FIG. 2 is a diagram for explaining a structure of multimedia data recorded on the storage medium shown in FIG. 1;

FIG. 3 is a diagram showing a structure of the clip AV stream 200 shown in FIG. 2;

FIG. 4 is a diagram showing a directory structure of a storage medium on which the data shown in FIG. 1 is recorded;

FIG. 5 is a block diagram of a reproducing apparatus according to an embodiment of the present invention;

FIG. 6 is block diagram of additional portions of the reproducing apparatus shown in FIG. 5;

FIG. 7 illustrates a data structure of meta information for reproducing data recorded on a storage medium along with downloaded data, according to an embodiment of the present invention;

FIG. 8 is a flowchart of a method of reproducing data recorded on a storage medium along with downloaded data by using meta information;

FIGS. 9 through 10B are diagrams for explaining a naming rule of a file, according to an embodiment of the present invention, in order to reproduce data recorded on a storage medium along with downloaded data;

FIG. 11 is a flowchart of a method of reproducing data recorded on a storage medium along with downloaded data by using a naming rule of a file; and

FIG. 12 illustrates an example of reproducing data according to the method shown in FIG. 11.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

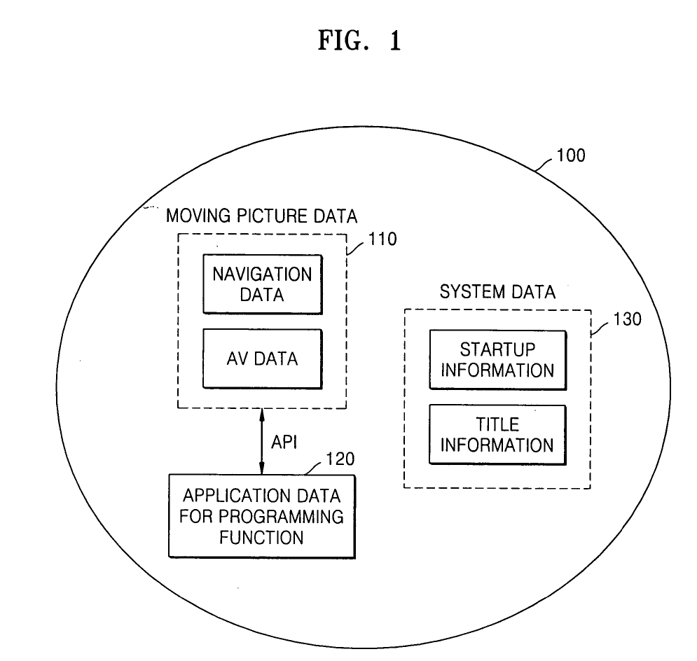

FIG. 1 illustrates types of data recorded on a storage medium 100 according to an embodiment of the present invention. Referring to FIG. 1, data recorded on the storage medium 100 includes moving picture data 110, application data 120 for a programming function, and system data 130.

The moving picture data 110 or movie mode data are data arranged in a reproducing mode, or a code mode, for reproducing moving pictures.

The moving picture data 110 includes compression-coded AV data and navigation data for controlling reproduction of the AV data. Accordingly, by referring to the navigation data of the storage medium, the AV data can be reproduced and a user can watch moving pictures such as a movie with a high picture quality.

The application data 120 is data providing an interactive function with the user, and is also referred to as full mode data or program mode data. The application data 120 can provide a variety of applications such as a game function using moving pictures, a function for displaying director's commentary while reproducing moving pictures, a function for displaying other additional information while reproducing part of the moving pictures, or a function for chatting while reproducing the moving pictures. Also, in relation to a movie recorded on a storage medium, related information, such as recent news of actors stored in a website or other databases, event plans related to the movie, or updated subtitles, can be obtained and reproduced together with the movie.

In order to execute an application program together with moving pictures, the application data 120 may include an application program interface (API) function for a presentation engine reproducing moving picture information, which is explained below. The application data 120 is generated using a programming language such as C or Java. In the present invention, it is assumed that the programming language is Java, in particular, xlet.

The system data 130 includes start-up information and title information. The start-up information indicates a location information of data to be first reproduced when data on the storage medium is reproduced by a reproducing apparatus. The title information indicates data entry and attribute information which may be provided when each title is reproduced.

As described above, the storage medium 100 includes the application data 120 that can be programmed, in addition to the moving picture data 110, such that the storage medium 100 can provide a variety of interactive functions with the user in addition to the reproducing of moving pictures.

In particular, in addition to the moving picture data 110 recorded on the storage medium 100, new contents may be downloaded from an external database and reproduced. Furthermore, by managing the downloaded data, the data can be used in a next reproduction.

Embodiments of the present invention will be explained with respect to a method of and an apparatus for appropriately connecting moving picture data recorded on a storage medium with new contents downloaded from an external database through a network, and reproducing the connected data.

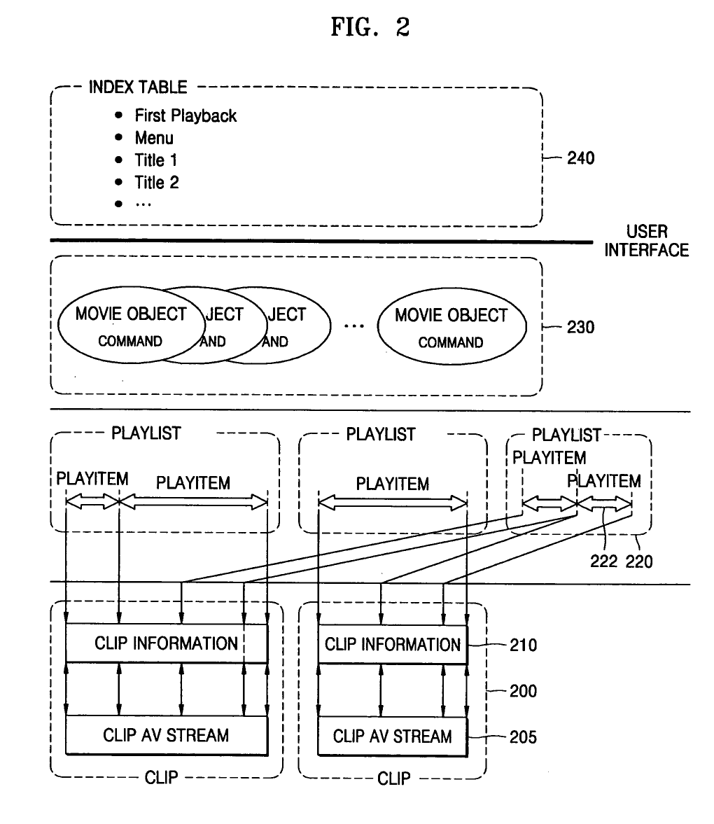

FIG. 2 is a diagram for explaining a structure of multimedia data recorded on the storage medium 100 shown in FIG. 1. Referring to FIG. 2, multimedia data recorded on the storage medium 100 may be formed in a 4-layer structure. Each layer includes a clip 200 that is a recording unit of a multimedia image, a playlist 220 that is a reproducing unit of a multimedia image, a movie object 230 that includes a navigation command for reproducing a multimedia image, and an index table 240 specifying a movie object to be first reproduced and each title included on the recording medium.

The clip 200 is obtained by implementing an AV data stream for a movie with high picture quality and an attribute of the AV data as one object. The AV data stream is referred to as a clip AV stream 205 and the attribute information of the AV data stream is referred to as clip information 210. The playlist 220 is a set of reproducing intervals of the clips, and each reproducing interval is referred to as a playitem 222. The movie object 230 is formed with navigation command programs, which start reproduction of a playlist, switch movie objects, or according to a preference of a user, manage the reproduction of a playlist. The index table 240 is a table at a top layer defining a plurality of titles and menus, and includes start location information of all titles and menus such that titles or menus selected by a user operation, such as a title search or menu call, may be reproduced. The index table 240 also includes start location information of a first title or menu that will be automatically executed when a storage medium is inserted into a reproducing apparatus.

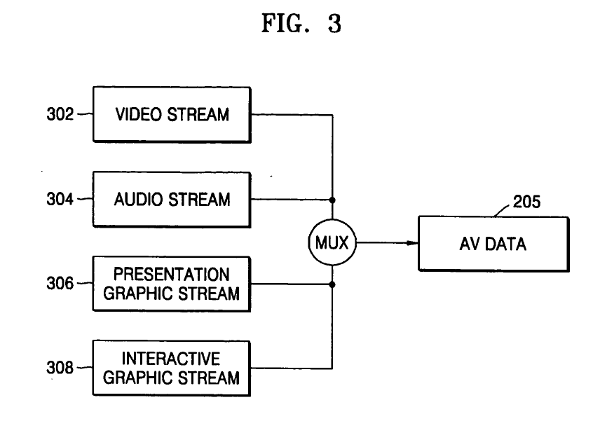

Among these data items, the structure of the clip AV stream 205 obtained by compression-coding a multimedia image will now be explained. FIG. 3 is a diagram showing a structure of the clip AV stream 205 shown in FIG. 2.

Referring to FIG. 3, the AV data stream 205 is obtained by multiplexing a video stream 302, an audio stream 304, a presentation graphic stream 306 providing a subtitle, and an interactive graphic stream 308 providing a menu for interaction with a user. The AV data stream 205 may also be referred to as a main stream.

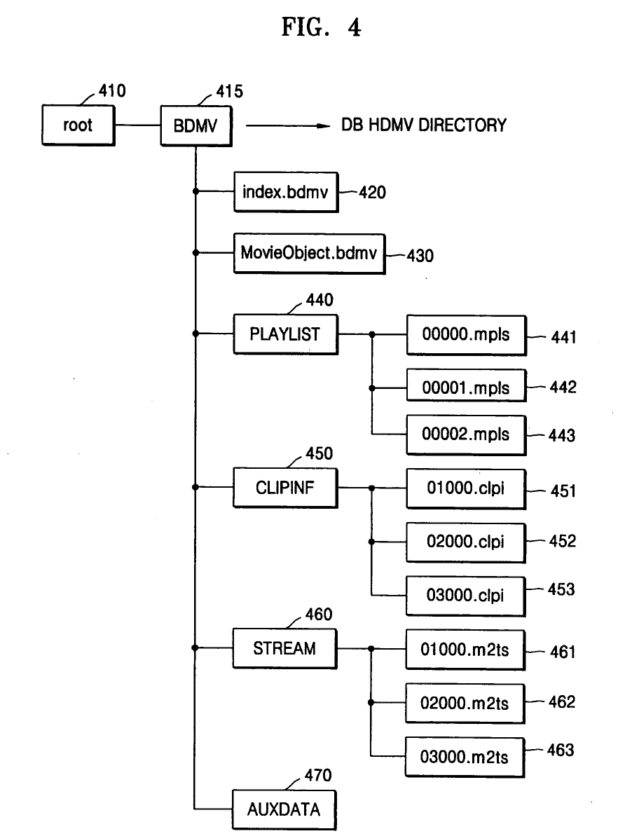

FIG. 4 is a diagram showing a directory structure of a storage medium 100 on which the data shown in FIG. 1 is recorded. Referring to FIGS. 2 and 4, there is shown the directory structure of files related to multimedia data recorded on the storage medium 100. In a BDMV directory 415 storing high picture quality moving picture data 110 below a root directory 410, directories for the index table 240, the movie object 230, the playlist 220, the clip information 210, the clip AV stream 205, and other data are disposed respectively.

More specifically, the index table 240 is stored as a file named index.bdmv 420, and the movie object 230 including navigation data is recorded as a file with the name MovieObject.bdmv 430. The playlist 220 that is a reproducing unit of moving pictures is recorded in a PLAYLIST directory 440 as files with respective names formed of a 5-digit number with an extension mpls (e.g. 441, 442, 443). The clip information 210 is recorded in a CLIPINF directory 450 as files with respective names formed of a 5-digit number and an extension clpi (e.g. 451, 452, 453). The clip AV stream 205 is recorded in a STREAM directory 460 as files with respective names formed of a 5-digit number and an extension m2ts (e.g. 461, 462, 463). In particular, a clip information file (451, 452, 453) and a corresponding clip AV stream file (461, 462, 463), respectively have names formed of an identical 5-digit number and different extensions. Also, other data such as a font file for a text subtitle may be stored in an AUXDATA directory 470.

According to embodiments of the present invention, data corresponding to all of the data described above can be downloaded, but for the convenience of explanation, only data corresponding to the clip AV stream, the clip information, and the playlist will now be explained. If a Java application for downloading data included in the application data 120 is executed, a file can be downloaded from an external database through a network and can be reproduced along with the moving picture data 110 recorded on the storage medium 100. A revised clip AV stream file, a revised clip information file, or a revised playlist may be separately downloaded to replace a corresponding object file on the storage medium 100, or a supplemental clip AV stream file, a supplemental clip information file, and/or a supplemental playlist may be downloaded as one unit and added to the files on the storage medium. The downloaded data are stored in a local storage as explained below. In order to allow easier connection to files on the storage medium 100, preferably, the downloaded data are stored in the local storage such that the downloaded data has a same directory structure as the data structure of the storage medium 100 shown in FIG. 4.

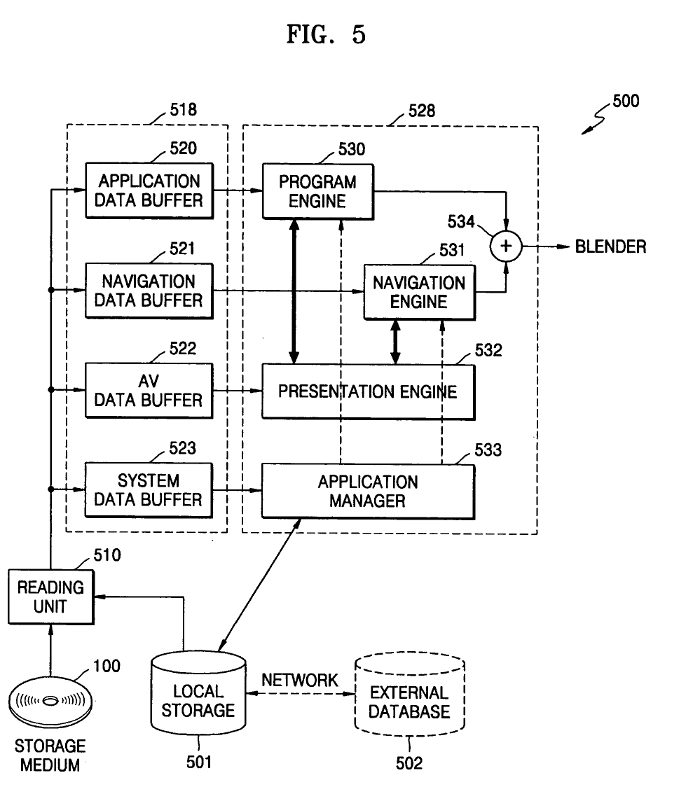

An apparatus for reproducing a storage medium 100 having the data structure described above with respect to FIGS. 1-4 will now be explained. FIG. 5 is a block diagram of reproducing apparatus 500 according to an embodiment of the present invention. Referring to FIG. 5, the apparatus 500 reproduces moving picture data and/or application data downloaded from an external database through a network, in addition to the moving picture data 110 and application data 120 recorded on the storage medium 100 shown in FIG. 1.

The apparatus 500 includes a reading unit 510, a buffer unit 518, and a reproducing unit 528. In particular, the reproducing unit 528 includes an application manager 533 controlling the reproduction of the application data 120. In addition to the data on the storage medium 100 described above with reference to FIG. 1, the reading unit 510 can download moving picture data, application data, and/or system data from an external database 502 through a network. The apparatus 500 includes a local storage 501 storing a variety of data items, that is, contents, downloaded from an external data.

More specifically, the reading unit 510 reads moving picture data, application data, and system data from the storage medium 100 or the local storage 501, and buffers the read data in the buffer unit 518 by type of data. The local storage 501 is an apparatus storing the moving picture data, application data, and/or system data downloaded from the external database 502 through a network.

The buffer unit 518 includes an application data buffer 520, a navigation data buffer 521, an AV data buffer 522, and a system buffer 523 according to the type of data to be buffered.

The reproducing unit 528 is an engine reproducing the buffered data. According to the type of buffered data, the application data are reproduced in a program engine 530, the navigation data are reproduced in a navigation engine 531, and the AV data are reproduced in a presentation engine 532.

In particular, the application manager 533 parses the system data, determines a mode (core mode or full mode) and data to be reproduced first, and controls the various engines 530 through 532 so that during the reproduction, the mode may be switched, or according to a title search request of a user, the requested title may be reproduced. Also, the application manager 533 transfers a user input, which is received through an input reception and processing unit (not shown) for processing an input of a user, to the reproduction engines 530 through 532. Further, by using an application for downloading or an application for managing a local storage, the application manager 533 manages the process of downloading application data from an external database, e.g., external database 502, through a network, and manages the local storage 501 so that the downloaded application data are appropriately stored in the local storage 501. Also, a module managing the downloading of data and the local storage 501 may be implemented separately from the application manager 533.

The presentation engine 532 decodes and reproduces the AV data and is controlled by the navigation engine 531. The program engine 530 executes the application data providing a programming function and controls the presentation engine 532 through an API. Accordingly, a variety of applications using moving pictures can be provided, for example, related additional information can be displayed while moving pictures are reproduced.

According to the control of the application manager 533, the apparatus 500 may read and reproduce the data on the storage medium 100 and may also read and reproduce the data downloaded from the external database 502 through a network and stored in the local storage 501.

As the application data are implemented by programming languages, like JAVA or JAVA script, incorrect operations or errors may be involved in the application data. Accordingly, where an operation is incorrect or an error not expected by the producer of a storage medium is included in the application provided by the storage medium, the moving picture data or application data having the error can be replaced. Also, an application providing an additional function not expected when the storage medium is produced, or updated moving pictures can be provided.

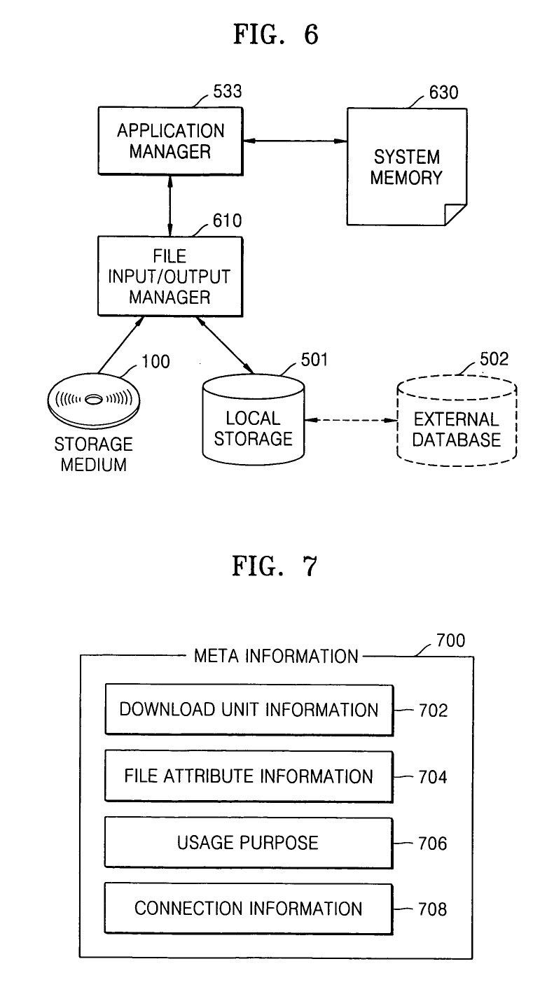

The operation of downloading data from an external database through a network and storing the data in a local storage may also be referred to as “download,” and binding various data stored in the local storage 501 with various data recorded on the storage medium 100 in a system memory (FIG. 6) may be referred to as “update.” The apparatus 500 can download the application data 120 and system data 130 as well as the moving picture data 110 from an external database, and reproduce the downloaded data along with the data recorded on the storage medium 100. However, for the convenience of explanation, only the downloaded moving picture data will now be explained.

FIG. 6 is a block diagram including another portion of the apparatus 500 shown in FIG. 5. Referring to FIG. 6, in order to reproduce the downloaded data, the reproducing apparatus 500 includes a file input/output manager 610 and a system memory 630 in addition to the application manager 533 described above with reference to FIG. 5.

The file input/output manager 610 reads data from the storage medium 100 and the local storage 501 storing the data downloaded from the external database 502 through a network, transfers the read data to the application manager 533, and records the downloaded data in the local storage 501.

The application manager 533 binds the data stored in the local storage 501 with the data recorded on the storage medium 100 by using an update API, generates a virtual file system and directory structure, and stores the generated virtual file and directory structure in the system memory 630. The bound information is subsequently accessed by the navigation engine and program engine described above. A specific example of the bound information is explained below.

The system memory 630 is a volatile memory storing the virtual file system and directory structure generated by using the bound information of the data file read from the storage medium 100 and the local storage 501. According to an application example, a working memory may be used in place of the system memory 630.

A process of binding data files of the storage medium with the downloaded data files in the local storage and reproducing the bound data files will now be explained in more detail with respect to the apparatus shown in FIGS. 5 and 6.

FIG. 7 illustrates an embodiment of a data structure of meta information for reproducing data recorded on a storage medium along with downloaded data. Referring to FIG. 7, an example of using meta information to bind data is shown. When moving picture data are downloaded from an external database by a Java application, the meta information 700 is downloaded together with the downloaded moving picture data and stored in the local storage 501. Unlike the data files shown in FIG. 4, the meta information 700 may be stored in a hidden file, in a separate storage space for meta information in the local storage 501 that is not in the root directory 410.

Referring again to FIG. 7, the meta information 700 includes download unit information 702, file attribute information 704, usage purpose information 706, and connection information 708. The download unit information 702 is information on a bundle of files downloaded by the Java application. That is, 702 is information on whether files are downloaded in units of files, or related files are bundled up and downloaded together. For example, as shown in FIG. 4, the playlist file, the clip information, or the clip AV data file may be downloaded in units of files, or the playlist file, the clip information file, and the clip AV data file related to one moving picture may be bundled up as one download unit and downloaded together.

The file attribute information 704 may include the name, size, version, storage location, producer, or other additional information of a file to be downloaded. In particular, in order to prevent redundant downloading, version information of the file may be included. The usage purpose information 706 may include information on the usage purpose of the file to be downloaded, such as a text subtitle for Korean, a text subtitle for English, moving picture trailer data of a latest version, and moving picture data introducing latest news of actors. Accordingly, the user can easily select the download of the related data.

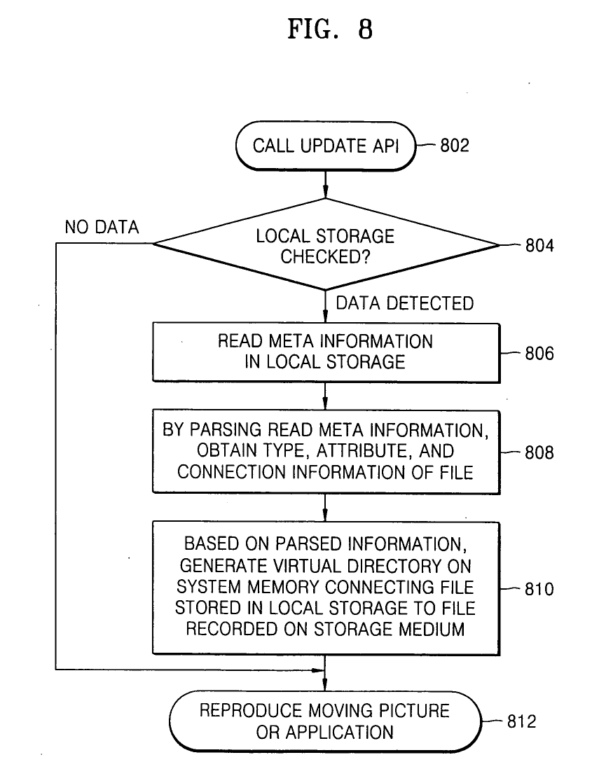

The connection information 708 is name information of a file on the storage medium 100 which is to be connected to the downloaded data file in the local storage 501. A process of connecting the data of the storage medium 100 and the downloaded data in the local storage 501 by using the meta information 700 will now be explained. FIG. 8 is a flowchart of operations performed by a method for reproducing data recorded on the storage medium 100 along with downloaded data on the local storage 501 by using the meta information 700.

Referring to FIGS. 6 and 8, in operation 802 an update operation is executed by calling an update API. In the update operation 802 various data stored in the local storage 501 and various data recorded on the storage medium 100 and stored in the system memory 630 are bound to each other. The update operation can be automatically executed by the application manager 533 shown in FIG. 6, when the storage medium is inserted into the reproducing apparatus and reproduction is performed for a first time or for a subsequent time. When the Java application completes the download, the update API is called such that the application manager 533 performs the update operation.

The application manager 533 confirms whether downloaded data exists by searching the local storage 501 through the file input/output manager 610 shown in FIG. 6 in operation 804. If downloaded data exists, the application manager reads the meta information 700 stored in a separate space on the local storage in operation 806, and by parsing the read meta information 700, obtains information on the type, version, and attribute of the downloaded data file stored in the local storage 501, and a data file on the storage medium 100 to be bound with the downloaded data file in operation 808.

Next, based on the parsed meta information, by binding the downloaded data file stored in the local storage 501 and the data file recorded on the storage medium 100, a virtual directory is generated in the system memory 630.

When the update operation 802 described above is completed, by using the virtual directory in the system memory 630, moving picture data are reproduced or an application is executed. Accordingly, the downloaded data may be smoothly reproduced together with the data recorded on the storage medium 100. That is, the navigation engine and the program engine can refer to the system memory 630 storing the virtual directory such that the downloaded data can be reproduced in addition to the data recorded on the storage medium.

The Java application provided by the reproducing apparatus can also manage the local storage 501 by using the meta information 700 described above. In particular, the meta information described above may include version information as one of the attribute information items in order to prevent redundant download when data are newly downloaded by the Java application for download after the meta information is downloaded.

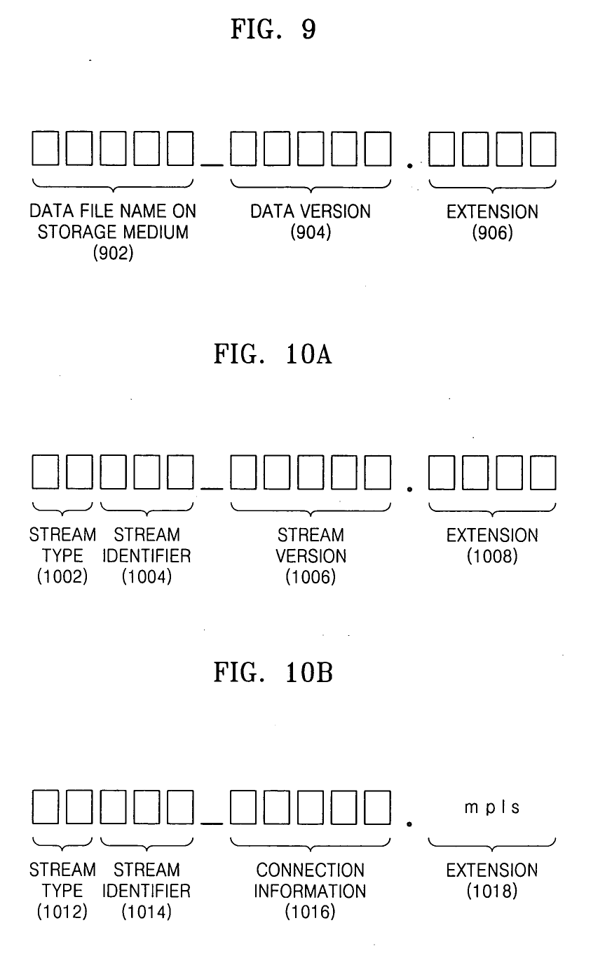

FIGS. 9 through 10B are diagrams for explaining a naming rule of a file, according to an embodiment of the present invention, in order to reproduce data recorded on a storage medium along with downloaded data. Referring to FIG. 9, an example of downloading only one file to replace a data file recorded on a storage medium 100 is shown. The name of the data file recorded on the storage medium 100 is formed of a 5-digit number and an extension as described above with reference to FIG. 4. Accordingly, for the name of the file to be downloaded, the name 902 of the data file recorded on the storage medium 100 desired to be replaced is used as connection information, and after an underbar (_), 5-digit version information 904 is added to avoid redundant download. Also, the same extension as that of the data file desired to be replaced is used as the extension 906 of the file to be downloaded.

FIGS. 10A and 10B show examples of downloading a data file such as a new text subtitle, a menu, and an audio stream. Referring to FIG. 1A, a file naming rule for downloading a data file such as a clip AV data file or a clip information file is shown. In the name of a file to be downloaded, the first two digits of the first five digits may indicate the type of a stream 1002 to be downloaded. For example, the type of the stream 1002 can be determined by the purpose of a clip AV data stream, and if, for example, the first two digits of the name of the file to be downloaded are 91, the first two digits may indicate a file for a menu, and if the first two digits are 92, the first two digits may indicate a file for a text subtitle.

Also, in the last three digits of the first five digits, a stream identifier 1004 of the clip AV data stream may be used. For example, in order to provide more detailed information on the data file to a user, an identifier determined with respect to a language, such as English, Korean, or Japanese, may be used.

Furthermore, after an underscore (_), in order to avoid redundant download, five-digit stream version information 1006 may be used. As the extension 1008, m2ts may be used for a clip AV stream and clpi may be used for a clip information file. In particular, in case of a clip information file corresponding to a clip AV stream 205, identical file names are used before extensions and only the extensions are different, e.g., m2ts and clpi.

Referring to FIG. 10B, a file naming rule for downloading a data file such as a playlist file is shown. In a similar manner as described with respect to FIG. 10A, the first two digits of the first five digits may indicate the type of a stream 1012 to be downloaded, and the last three digits of the first five digits may indicate the stream identifier 1014 of the playlist stream. However, unlike the clip AV stream file or the clip information file named as shown in FIG. 10A, the playlist stored in the local storage should be connected to the playlist of the main video stream (refer to FIG. 3). Accordingly, in case of a playlist, a separate file naming rule may be applied as shown in FIG. 10B. That is, for the first five digits, the concept of the download unit is maintained as explained with reference to FIG. 10A and a same name as the related clip file name is used when the local storage is managed. Also, the name of the playlist recorded on the storage medium to be connected is used as the five digits after the underscore (_) to provide connection information 1016. For the extension 1018, mpls used. If the name of a file to be downloaded is parsed according to the file naming rule described above, the binding information described with reference to FIG. 8 can be parsed.

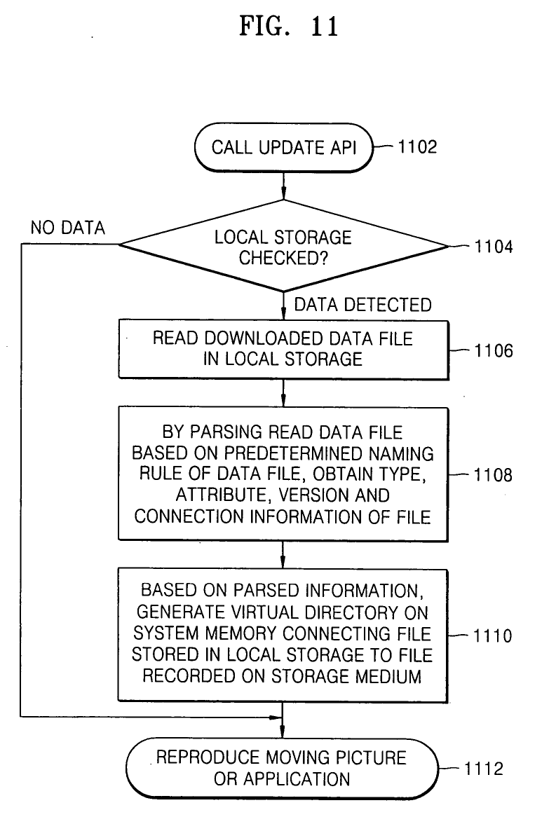

FIG. 11 is a flowchart of a method of reproducing data recorded on a storage medium along with downloaded data by using a naming rule of a file. Referring to FIGS. 6 and 11, in operation 1102 an update operation is executed by calling an update API. The application manager 533 confirms whether downloaded data exist, by searching the local storage 501 through the file input/output manager 610 shown in FIG. 6 in operation 1104.

If the downloaded data exist, the application manager reads the downloaded data file from the local storage 501 in operation 1106. Then, based on the file naming rules described above with reference to FIGS. 9 through 10B, the name of the read data file is parsed, and information on the type, version, and attribute of the downloaded data file stored in the local storage, and a data file on the storage medium 100 that should be bound with the downloaded data file is obtained in operation 1108.

Next, by binding the downloaded data file stored in the local storage 501 and the data file recorded on the storage medium 100 based on the parsed information, a virtual directory is generated in the system memory 630 in operation 1110. When the update operation described above is completed, by using the virtual directory in the system memory 630, moving picture data are reproduced or an application is executed. According to this, the downloaded data from the external database 502 can be smoothly reproduced together with the data recorded on the storage medium 100.

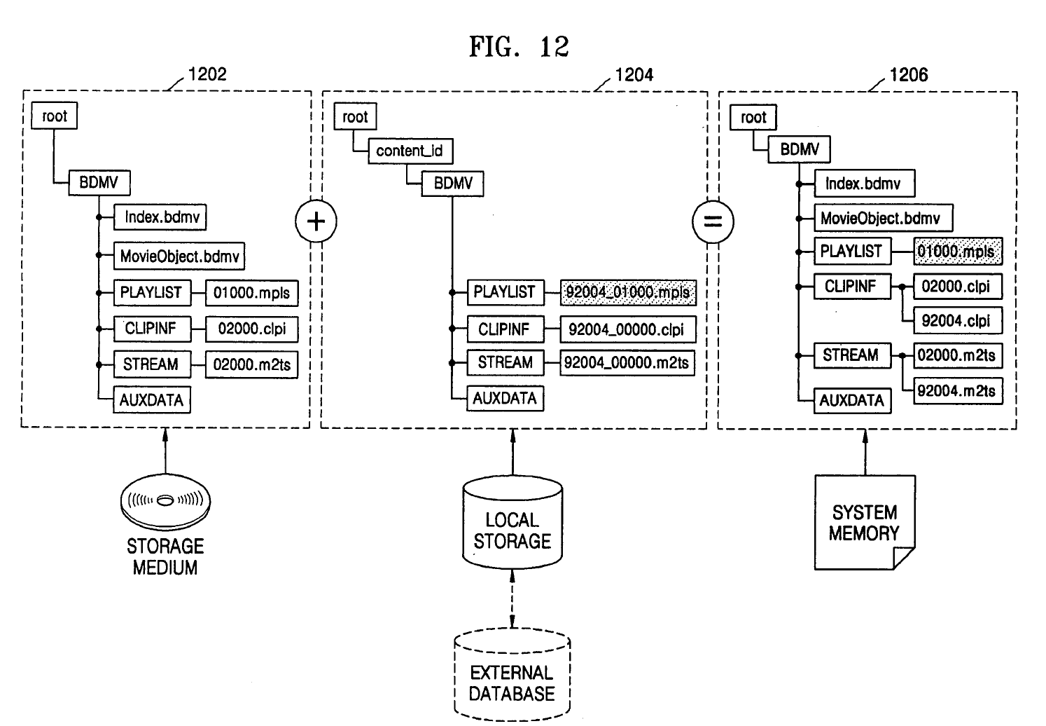

FIG. 12 illustrates an example of reproducing data according to the method shown in FIG. 11. FIG. 12 shows an example of binding data files recorded on a storage medium 1202 and downloaded data in a local storage 1204 by using the file naming rules shown in FIGS. 9 through 10B and generating a virtual directory structure in a system memory 1206. First, on a storage medium 1202, a playlist file with a name 01000.mpls, a clip information file with a name 02000.clpi, and a clip AV data file with a name 02000.m2ts are recorded.

In the local storage 1204, a playlist with a name 92004_{—}01000.mpls, a clip information file with a name 92004_{—}00000.clpi, and a clip AV data file with the name 92004_{—}00000.m2ts are stored as new text subtitle data downloaded from an external database. Since the first two digits of the first five digits are 92 as described above with reference to FIG. 10A, it can be known that the usage purpose of the file is for a text subtitle. Since the first five digits of the name of each the file stored in the local storage is 92004, it can be known that three files are one download unit. Also, in case the downloaded playlist file, since the name has a five digit number 01000 after the underscore (_), it can be known that the playlist of the main stream that should be added is 01000.mpls.

Accordingly, according to the file naming rules described above, the application manager generates a file named 01000.mpls as a playlist file, a file named 92004.clpi as a clip information file, and a file named 92004.m2ts as a clip AV data file in the system memory 1206. Thus, the virtual directory for the data recorded on the storage medium and the downloaded data stored in the local storage is generated in the system memory according to the file naming rules described above, such that both data items can be smoothly reproduced together.

As described above, according to embodiments and aspects of the present invention, a method and apparatus by which new contents downloaded from an external database through a network are reproduced along with moving picture data recorded on a storage medium are provided. Accordingly, contents stored in a local storage after being downloaded from an external database may be smoothly reproduced along with data recorded on the storage medium.

Further, where an error or incorrect operation not expected by the producer of a storage medium is included in the application provided by the storage medium, the moving picture data or application data having the error can be replaced. Also, an application providing an additional function not expected when the storage medium is produced, or updated moving pictures can be provided.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of reproducing data from a storage medium on which moving picture data and application data providing an interactive function using the moving picture data are recorded, the method comprising:
binding data downloaded from an external database through a network with the data recorded on the storage medium; and
reproducing together the bound data recorded on the storage medium and the bound data downloaded.

2. The method of claim 1, wherein the binding of the data further comprises:
generating a directory structure of a data file to be reproduced by using meta information for connecting the downloaded data with the data recorded on the storage medium.

3. The method of claim 2, wherein the meta information comprises information on a data file which is recorded on the storage medium and connectable with the downloaded data.

4. The method of claim 3, wherein the meta information further comprises version information of the downloaded data to avoid redundant downloading of the downloaded data.

5. The method of claim 3, wherein the meta information further comprises information on a usage purpose of the downloaded data.

6. The method of claim 3, wherein the meta information further comprises information on a download unit.

7. The method of claim 3, further comprising:
downloading the meta information from the external database together with the downloaded data.

8. The method of claim 3, further comprising:
storing the meta information in a separate area of a local storage in a reproducing apparatus.

9. The method of claim 3, further comprising:
storing the meta information as an attribute of a hidden file.

10. The method of claim 2, wherein the reproducing of the bound data further comprises:
reproducing the data file based on the directory structure of the data file generated in the binding of the data.

11. The method of claim 1, wherein the binding of the data further comprises:
generating a data structure of a data file to be reproduced using a predetermined file naming rule, in order to connect the downloaded data with the data recorded on the storage medium to reproduce the downloaded data along with the recorded data.

12. The method of claim 11, wherein:
where only one data file is downloaded to replace a predetermined file on the storage medium, a name of the data file to be downloaded includes a name of the file desired to be replaced and version information to avoid redundant download.

13. The method of claim 11, wherein:
where a plurality of data files are to be provided additionally to the main video stream of the storage medium, the name of each of the plurality of data files includes an identical name to indicate that the plurality of data files are one download unit.

14. The method of claim 13, wherein:
where a clip audio visual (AV) stream file is to be downloaded, the name of the data file to be downloaded further includes information indicating a usage purpose of the clip AV stream.

15. The method of claim 14, wherein:
where the clip AV stream file is to be downloaded, the name of the data file to be downloaded further includes information on an identifier of the clip AV stream file.

16. The method of claim 15, wherein:
where the clip AV stream file is to be downloaded, the name of the data file to be downloaded further includes version information of the clip AV stream file.

17. The method of claim 13, wherein:
where a clip AV stream file is to be downloaded, the name of the data file to be downloaded includes a same name as the name of the clip AV stream file.

18. The method of claim 13, wherein:
where a playlist file that is a reproduction unit of a clip is to be downloaded, the name of the data file to be downloaded further includes information on a playlist in the storage medium to be connected.

19. An apparatus for reproducing data from a storage medium on which moving picture data and application data providing an interactive function using the moving picture data are recorded, the apparatus comprising:
a reading unit reading data recorded on the storage medium;
a storage unit storing data downloaded from an external database through a network; and
a reproducing unit reproducing data read from the storage medium along with the downloaded data stored in the storage unit,
wherein the reproducing unit comprises an application manager binding the downloaded data with the data recorded on the storage medium.

20. The apparatus of claim 19, wherein the application manager generates a directory structure of a data file to be reproduced by using meta information for connecting the downloaded data with the data recorded on the storage medium to reproduce the downloaded data along with the recorded data.

21. The apparatus of claim 19, wherein the application manager generates a directory structure of a data file to be reproduced by using a predetermined file naming rule in order to connect the downloaded data with the data recorded on the storage medium and reproduce the downloaded data along with the recorded data.

22. The apparatus of claim 19, wherein the application data are implemented by using a programming language.

23. The apparatus of claim 22, wherein the programming language is Java.

24. A method of supplementing first contents distributed on an optical recording medium, the method comprising:
downloading a supplemental file from an external database;
storing the supplemental file in a local storage medium;
generating a virtual data structure in a system memory, the virtual data structure comprising files of the distributed first contents and the supplemental file organized in a data structure corresponding to a data structure of the distributed optical recording medium; and
displaying second contents based on the virtual data structure.

25. The method of claim 24, wherein the first contents comprise moving picture data.

26. The method of claim 24, wherein the generating of the virtual data structure comprises replacing one file of the first contents with the downloaded supplemental file.

27. The method of claim 24, wherein the generating of the virtual data structure comprises adding the supplemental file to the first contents.

28. The method of claim 26, wherein a predetermined first portion of a file name of the supplemental file corresponds to a file name of one file of the first contents which is to be replaced by the supplemental file and a predetermined second portion of the file name of the supplemental file corresponds to version information of the supplemental file.

29. The method of claim 27, wherein predetermined first, second and third portions of a file name of the supplemental file correspond to a stream type, a stream identifier, and a stream version, respectively.

30. The method of claim 27, wherein predetermined first, second and third portions of a file name of the supplemental file correspond to a stream type, a stream identifier, and a connection information, respectively, the connection information indicating a file of the first contents to which the supplemental file is to be added.

31. The method of claim 26, wherein the supplemental file replaces a defective file of the first contents.

32. The method of claim 25, wherein the supplemental file includes data relating to recent news of actors in a movie, event plans related to the movie, updated subtitles for the movie, or trailer data.

33. The method of claim 8, wherein the separate area is a hidden file which is not stored in a same root directory as the downloaded data file.

34. The method of claim 2, further comprising:
generating a virtual directory in a system memory based on the bound downloaded data, data from the storage medium and the meta information; and
reproducing a moving picture or performing an application based on the virtual directory.

35. The apparatus of claim 20, further comprising:
a system memory; and
a navigation engine, wherein:
the application manger generates a virtual directory in the system memory using the read data from the storage medium and bound data from the storage unit, and
the navigation engine refers to the virtual directory to reproduce the downloaded data along with the recorded data.
